(19) United States
(12) Patent Application Publication
(10) Pub. No.: US 2017/0221438 A1
(43) Pub. Date: Aug. 3, 2017

(54) METHOD AND APPARATUS FOR SIGNAL POLARITY CONTROL IN DISPLAY DRIVING

(71) Applicant: Shenzhen Yunyinggu Technology Co., Ltd., Shenzhen (CN)

(72) Inventors: Jing GU, Shanghai (CN); Xixi Luo, Shanghai (CN)

(21) Appl. No.: 15/486,986

(22) Filed: Apr. 13, 2017

Related U.S. Application Data
(63) Continuation of application No. PCT/CN2015/072738, filed on Feb. 11, 2015.

(51) Int. Cl. G09G 3/36

(52) U.S. Cl. CPC G09G 3/3614; G09G 3/3677; G09G 2310/08

(57) ABSTRACT

An apparatus includes a data storage, a data converter, and a source driver. The data storage is configured to receive display data in a plurality of frames. The data converter is operatively coupled to the data storage and configured to convert the received display data into a source voltage signal for each column of the array of the pixels. The source driver is operatively coupled to the data converter and configured to apply the respective source voltage signal to each column of the array of the pixels. For each column of the array of the pixels, a polarity of the source voltage signal applied to the column remains the same in at least two consecutive frames of the plurality of frames.

### CROSS REFERENCE TO RELATED APPLICATION

This application is continuation of International Application No. PCT/CN2015/072738, filed on Feb. 11, 2015, entitled “METHOD AND APPARATUS FOR SIGNAL POLARITY CONTROL IN DISPLAY DRIVING,” which is hereby incorporated by reference in its entirety.

### BACKGROUND

The disclosure relates generally to displays, and more particularly, to signal polarity control in display driving.

In liquid crystal display (LCD), it is only the magnitude of the applied voltage signal which determines the light transmission as the transmission versus voltage function is symmetrical about 0 V. To prevent internal polarization and rapid permanent damage of the liquid crystal material due to ion impurity, the polarity of the pixel voltage is inverted on alternate display frames in prior art methods for driving LCD displays. For example, as shown in FIG. 11, the polarity of the source voltage signal applied to scan line 1 (S1) remains positive in frame 1 (though the voltage magnitude changes in frame 1) and switches to negative in frame 2.

On the other hand, because the display panel refresh rate is normally at 60 Hz to prevent flickering caused by pixel voltage loss due to leakage current, the polarity of source voltage signals is also switched at the same frequency as the frame rate. Once the source voltage varies, a source line charge or discharge occurs, which is a major contribution of display panel power consumption. Part of the source line charge or discharge is caused by the relatively high frequency (e.g., 60 Hz) of the voltage polarity inversion.

### SUMMARY

The present disclosure describes apparatus and method for signal polarity control in display driving. In one example, an apparatus including a data storage, a data converter, and a source driver is disclosed. The data storage is configured to receive display data in a plurality of frames. The data converter is operatively coupled to the data storage and configured to convert the received display data into a source voltage signal for each column of the array of the pixels. The source driver is operatively coupled to the data converter and configured to apply the respective source voltage signal to each column of the array of the pixels. For each column of the array of the pixels, a polarity of the source voltage signal applied to the column remains the same in at least two consecutive frames of the plurality of frames.

In another example, an apparatus including an LCD panel and a display driver is disclosed. The LCD panel has an array of pixels. The display driver is operatively coupled to the LCD panel and configured to drive the array of pixels on the LCD panel. The display driver includes a timing controller, a gate driving module, and a source driving module. The timing controller is configured to receive display data in a plurality of frames and provide control signals based on the display data. The gate driving module is operatively coupled to the timing controller and configured to scan each row of the array of the pixels in each of the plurality of frames based on the control signals. The source driving module is configured to apply a source voltage signal to each column of the array of the pixels based on the control signals. For each column of the array of the pixels, a polarity of the source voltage signal applied to the column remains the same in at least two consecutive frames of the plurality of frames.

In still another example, a method for driving a display panel having an array of pixels is disclosed. Display data in a plurality of frames is received. The received display data is converted into a source voltage signal for each column of the array of the pixels. The respective source voltage signal is applied to each column of the array of the pixels. For each column of the array of the pixels, a polarity of the source voltage signal applied to the column remains the same in at least two consecutive frames of the plurality of frames.

In yet another example, a non-transitory computer-readable medium storing instructions thereon is disclosed. The stored instructions, when executed by one or more integrated circuit design systems, cause the one or more integrated circuit design systems to design an integrated circuit including a data storage, a data converter, and a source driver. The data storage is configured to receive display data in a plurality of frames. The data converter is operatively coupled to the data storage and configured to convert the received display data into a source voltage signal for each column of the array of the pixels. The source driver is operatively coupled to the data converter and configured to apply the respective source voltage signal to each column of the array of the pixels. For each column of the array of the pixels, a polarity of the source voltage signal applied to the column remains the same in at least two consecutive frames of the plurality of frames.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram illustrating an apparatus including a display in accordance with one embodiment set forth in the disclosure;

FIG. 2 is a side-view diagram illustrating one example of the display of the apparatus shown in FIG. 1 in accordance with one embodiment set forth in the disclosure;

FIG. 3 is a plan-view diagram illustrating one example of the display of the apparatus shown in FIG. 1 in accordance with one embodiment set forth in the disclosure;

FIG. 4 is a block diagram illustrating one example of a display driver of the display shown in FIG. 1 in accordance with one embodiment set forth in the disclosure;

FIG. 5A is a plan-view diagram illustrating an array of pixels on the display shown in FIG. 1 in accordance with one embodiment set forth in the disclosure;

FIG. 5B is a timing diagram of a plurality of source voltage signals in a plurality of frames in accordance with one embodiment set forth in the disclosure;

FIGS. 6A-6C are depictions of various voltage polarity inversion schemes in display driving in accordance with different embodiments set forth in the disclosure;

FIGS. 7-8 are timing diagrams of source voltage signal polarity of each pixel column in accordance with different embodiments set forth in the disclosure;

FIG. 9 is a flow chart illustrating one example of a method for driving the display of the apparatus shown in FIG. 1 in accordance with one embodiment set forth in the disclosure;

FIG. 10 is a flow chart illustrating another example of a method for driving the display of the apparatus shown in FIG. 1 in accordance with one embodiment set forth in the disclosure; and

FIG. 11 is a prior art timing diagram of a plurality of source voltage signals in a plurality of frames.

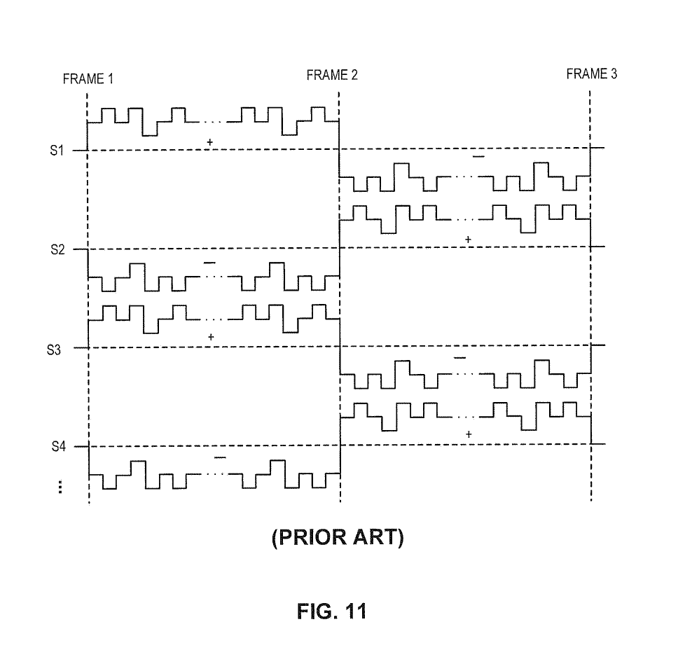

### DETAILED DESCRIPTION

In the following detailed description, numerous specific details are set forth by way of examples in order to provide a thorough understanding of the relevant disclosures. However, it should be apparent to those skilled in the art that the present disclosure may be practiced without such details. In other instances, well known methods, procedures, systems, components, and/or circuitry have been described at a relatively high-level, without detail, in order to avoid unnecessarily obscuring aspects of the present disclosure.

Throughout the specification and claims, terms may have nuanced meanings suggested or implied in context beyond an explicitly stated meaning. Likewise, the phrase “in one embodiment/example” as used herein does not necessarily refer to the same embodiment and the phrase “in another embodiment/example” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Among other novel features, the present disclosure provides the ability to reduce the display panel power consumption by decreasing the source voltage polarity inversion frequency. The voltage polarity inversion frequency necessary for avoiding liquid crystal polarization is much lower than the normal display frame rate, and higher inversion frequency causes higher power consumption. Thus, it is unnecessary to keep voltage polarity switches at the same frequency as the frame rate. The present disclosure describes various embodiments of decreasing the source voltage polarity inversion frequency. In one embodiment of the present disclosure, the voltage polarity alters in at least every two consecutive frames. In another embodiment of the present disclosure, the voltage polarity may dynamically remain the same for several consecutive frames so long as the total duration of positive frames and total duration of negative frames are the same in a certain time period. Moreover, the present disclosure may be applied to any voltage polarity inversion schemes in which, for each source line (pixel column), the voltage polarity remains the same within each frame, such as the frame inversion scheme, column inversion scheme, 2-column inversion scheme, etc.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities, and combinations set forth in the detailed examples discussed below.

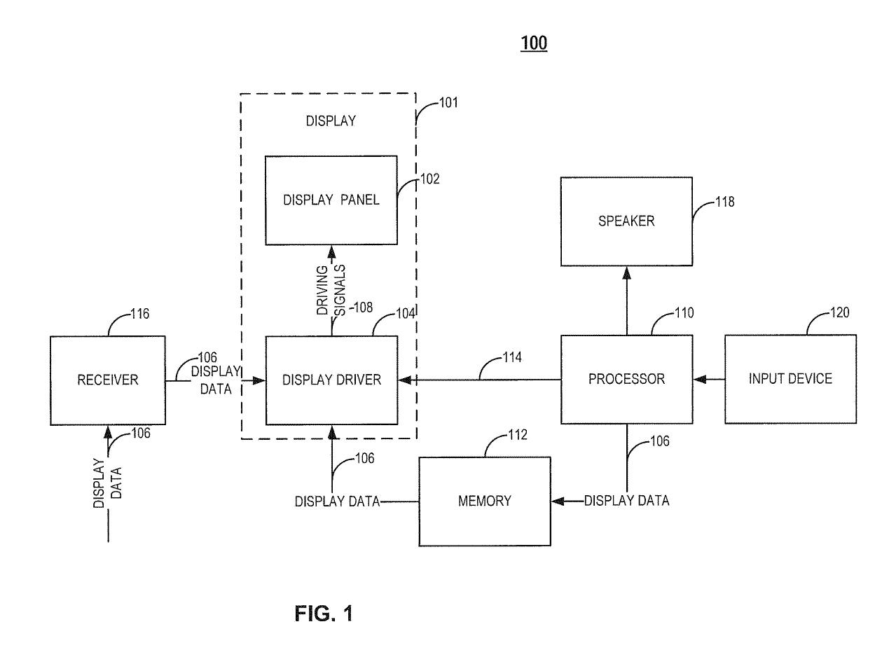

FIG. 1 illustrates an apparatus 100 including a display 101. The apparatus 100 may be any suitable device, for example, a television set, laptop computer, desktop computer, netbook computer, media center, mobile device (e.g., dumb or smart phone, tablet, etc.), wearable devices (e.g., eyeglasses, wrist watch, etc.), global positioning system (GPS), electronic billboard, gaming console, set-top box, printer, or any other suitable device. In this example, the display 101 is operatively coupled to other components of the apparatus 100 and is part of the apparatus 100, such as but not limited to, a television screen, computer monitor, dashboard, head-mounted display, or electronic billboard. The display 101 may be an LCD, or any other suitable type of display. The display 101 may include a display panel 102 and a display driver 104.

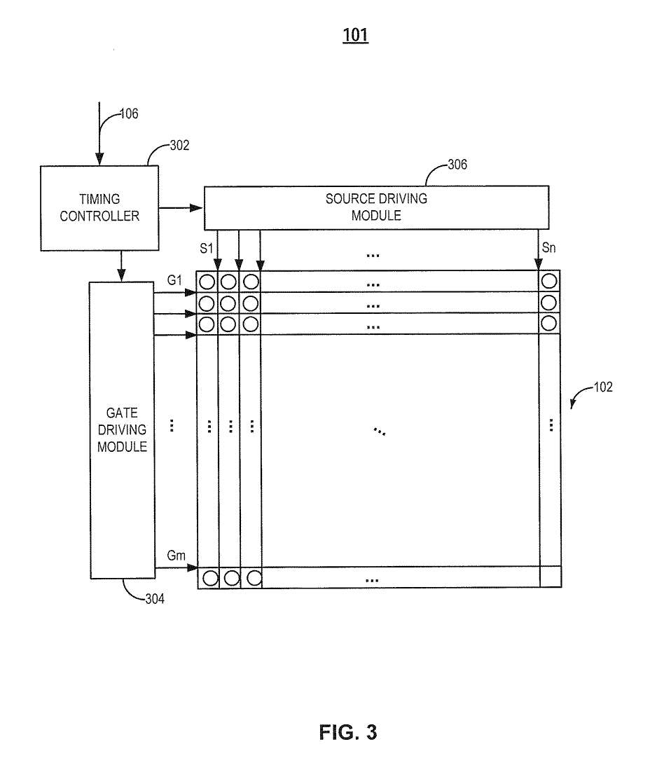

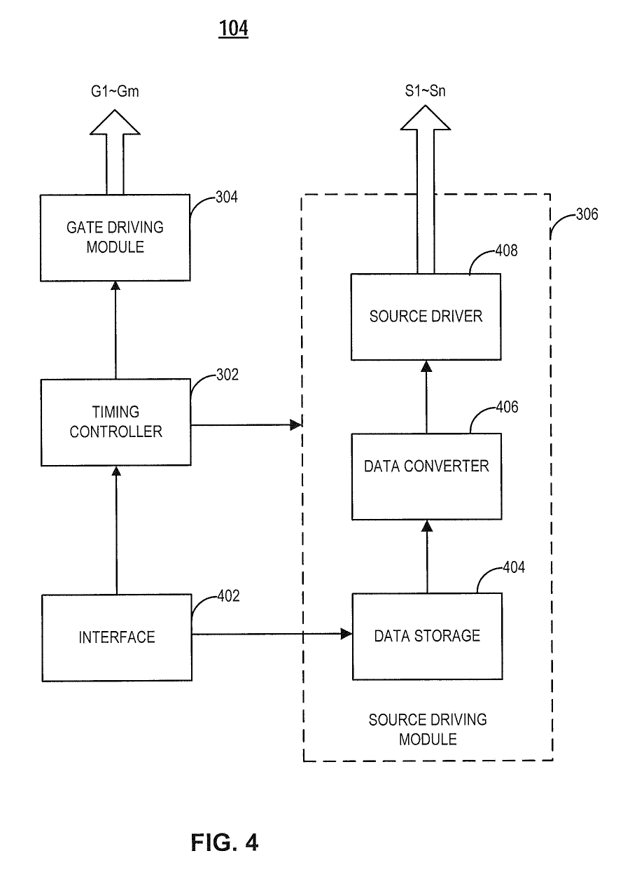

The display driver 104 of the display 101 may be any suitable hardware, software, firmware, or combination thereof, configured to receive display data 106 and provide driving signals 108 based on the received display data 106. The driving signals 108 are used for controlling writing of pixels and directing operations of the display panel 102. As described below in detail with respect to FIGS. 3 and 4, the display driver 104 may include a timing controller, a gate driving module, and a source driving module. The display driver 104 may include any other suitable components, including an encoder, a decoder, one or more processors, controllers, and storage devices. The display panel 102 has an array of pixels arranged in multiple rows and columns.

In one example, the apparatus 100 may be a laptop or desktop computer having a display 101. In this example, the apparatus 100 also includes a processor 110 and memory 112. The processor 110 may be, for example, a graphic processor (e.g., GPU), a general processor (e.g., APU, accelerated processing unit; GPGPU, general-purpose computing on GPU), or any other suitable processor. The memory 112 may be, for example, a discrete frame buffer or a unified memory. The processor 110 is configured to generate display data 106 in display frames (video frames) and temporally store the display data 106 in the memory 112 before sending it to the display driver 104. The processor 110 may also generate other data, such as but not limited to, control instructions 114 or test signals, and provide them to the display driver 104 directly or through the memory 112. The display driver 104 then receives the display data 106 from the memory 112 or from the processor 110 directly.

In another example, the apparatus 100 may be a television set having a display 101. In this example, the apparatus 100 also includes a receiver 116, such as but not limited to, an antenna, radio frequency receiver, digital signal tuner, digital display connectors, e.g., HDMI, DVI, DisplayPort, USB, Bluetooth, WiFi receiver, or Ethernet port. The receiver 116 is configured to receive display data 106 as an input of the apparatus 100 and provide the native or modulated display data 106 to the display driver 104.

In still another example, the apparatus 100 may be a mobile device, such as a smart phone or a tablet. In this example, the apparatus 100 includes the processor 110, memory 112, and receiver 116. The apparatus 100 may both generate display data 106 by its processor 110 and receive display data 106 through its receiver 116. For example, the apparatus 100 may be a mobile device that works as both a portable television and a portable computing device. In any event, the apparatus 100 at least includes the display 101 with an array of pixels as described below in detail.

The apparatus 100 may also include any other suitable component such as, but not limited to, a speaker 118 and an input device 120, e.g., a mouse, keyboard, remote controller, handwriting device, camera, microphone, scanner, etc.

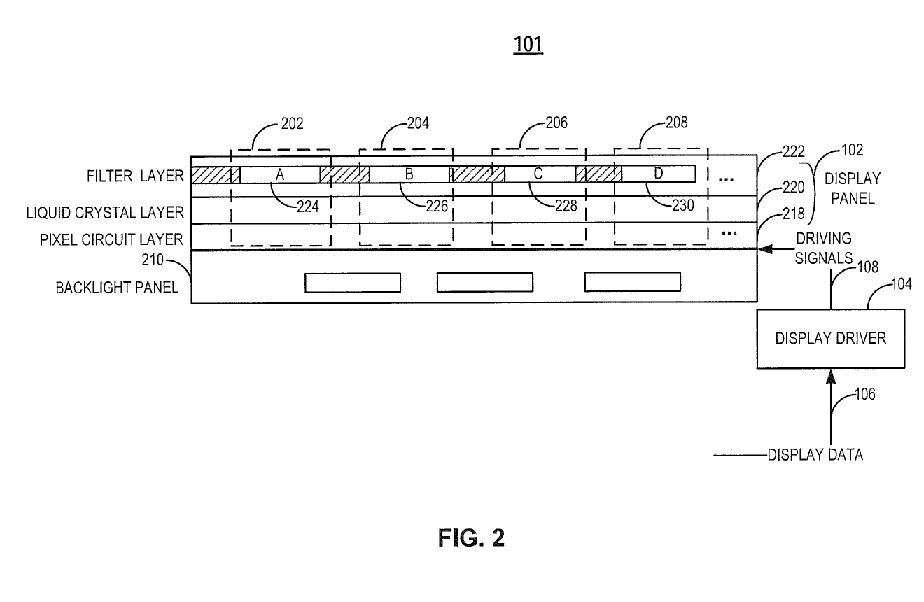

FIG. 2 illustrates one example of a side-view of the display 101 including an array of pixels 202, 204, 206, 208. The display 101 may be any suitable type of LCDs, for example, a twisted nematic (TN) LCD, in-plane switching (IPS) LCD, advanced fringe field switching (AFFS) LCD, vertical alignment (VA) LCD, advanced super view (ASV) LCD, blue phase mode LCD, passive-matrix (PM) LCD, or any other suitable display. The display 101 may include the display panel 102, the display driver 104, and a backlight panel 210. The backlight panel 210 includes light sources for providing lights to the display panel 102, such as but not limited to, incandescent light bulbs, LEDs, EL panel, cold cathode fluorescent lamps (CCFLs), and hot cathode fluorescent lamps (HCFLs), to name a few.

The display panel 102 may be, for example, a TN panel, an IPS panel, an AFFS panel, a VA panel, an ASV panel, or any other suitable display panel. In this example, the display panel 102 includes a pixel circuit layer 218, a liquid crystal layer 220, and a filter layer 222. The liquid crystal layer 220 is disposed between the filter layer 222 and the pixel circuit layer 218. As shown in FIG. 2, the filter layer 222 includes a plurality of filters 224, 226, 228, 230 corresponding to the plurality of pixels 202, 204, 206, 208, respectively. A, B, C, and D in FIG. 2 denote four different types of filters, such as but not limited to, red, green, blue, yellow, cyan, magenta, or white filter. The filter layer 222 may also include black matrix, as the borders of the pixels 202, 204, 206, 208, used for blocking lights coming out from the parts outside each pixel region. In this example, the pixel circuit layer 218 includes a plurality of pixel circuits, each having multiple thin film transistors (TFTs) and capacitors, corresponding to the plurality of pixels 202, 204, 206, 208, respectively. Each pixel circuit may be individually addressed by the driving signals 108 from the display driver 104 and is configured to drive the corresponding pixels 202, 204, 206, 208 by controlling light passing through the corresponding liquid crystal in each pixel. For example, the gate electrode of a TFT in each pixel circuit is coupled to the gate driving module of the display driver 104, and the source of the TFT is coupled to the source driving module of the display driver 104. The display panel 102 may include any other suitable component, such as one or more glass substrates, polarization layers, or a touch panel, as known in the art.

FIG. 3 is a plan-view diagram of one example of the display 101. The display panel 102 has an array of pixels arranged in multiple rows and columns. In this example, the display driver 104 of the display 101 includes a timing controller (TCON) 302, a gate driving module 304, and a source driving module 306. The TCON 302 is configured to receive the display data 106 in multiple frames. The display data 106 is received in consecutive frames at any frame rate used in the art, such as 30, 60, or 72 Hz. Based on received display data 106, the TCON 302 provides control signals to the gate driving module 304 and source driving module 306, respectively. The gate driving module 304 in this example applies gate driving signals G1-Gm, which are generated based on the control signals from the TCON 302, to the gate lines for each row of pixels in a sequence. As mentioned above, the gate driving signals G1-Gm are applied to the gate electrode of each TFT to turn on the corresponding TFT by applying a gate voltage so that the data for the corresponding pixel may be written by the source driving module 306. The gate driving module 304 in this example may include a digital-analog converter (DAC) and multiplexers (MUX) for converting the digital control signals to analog scan voltage signals G1-Gm and applying the scan voltage signals G1-Gm to the scan lines of each row of pixels according to the preset scanning sequences. It is understood that although one gate driving module 304 is illustrated in FIG. 3, in other examples, multiple gate driving modules may work in conjunction with each other to scan the pixel rows.

The source driving module 306 in this example is configured to write the display data 106 into the array of pixels based on the control signals from the TCON 302 in each frame. For example, the source driving module 306 may simultaneously apply the source voltage signals S1-Sn to the data lines of each column of pixels. That is, the source driving module 306 may include a DAC, MUX, and arithmetic circuit for controlling, based on the control signals, a timing of application of voltage to the source electrode of each TFT and a magnitude of the applied voltage according to gradations of the display data 106. As mentioned above and will be described below in detail, for each column of the pixels, a polarity of the source voltage signal applied by the source driving module 306 to the column remains the same in at least two consecutive frames of the display data 106. In other words, the voltage polarity inversion frequency set by the source driving module 306 is higher than the frame rate of the received display data 106. It is understood that although one source driving module 306 is illustrated in FIG. 3, in other examples, multiple source driving modules may work in conjunction with each other to apply source voltage signals S1-Sn to the data lines of each column of pixels.

FIG. 4 is a block diagram illustrating one example of the display driver 104. In this example, the display driver 104 is an integrated circuit (but may alternatively include a state machine made of discrete logic and other components), which provides an interface function between the processor 110/memory 112 and the display panel 102. The display driver 104 may provide the driving signals 108 with suitable voltage, current, timing, and/or de-multiplexing, to make the display panel 102 show the desired text or image. The display driver 104 may be an application-specific microcontroller and may include storage units such as RAM, flash memory, EEPROM, and/or ROM, which may store, for example, firmware and display fonts. In this example, the display driver 104 includes the TCON 302, the gate driving module 304, the source driving module 306, and an interface 402.

The interface 402 may be any serial or parallel interface, such as but not limited to, TTL, CMOS, RS-232, SPI, I²C, etc. The interface 402 is configured to receive the display data 106 in multiple frames and any other control instructions 114 or test signals. The received display data 106 is forwarded by the interface 402 to the TCON 302 and source driving module 306. As mentioned above, the TCON 302 provides control signals to both the gate driving module 304 and the source driving module 306. Based on the received control signals, the gate driving module 304 is configured to scan each row of the pixels in each frame by the scan voltage signals G1-Gm, respectively, in a sequence.

The source driving module 306 in this example includes a data storage 404, a data converter 406, and a source driver 408. The data storage 404 may be data latches that temporally store the display data 106 forwarded by the interface 402. The data converter 406 in this example includes DAC and any other logic that converts the receive display data 106 into the source voltage signals S1-Sn for each column of pixels. The source driver 408 is configured to apply the source voltage signals S1-Sn to each column of the pixels, respectively. In generating the source voltage signals S1-Sn, the data converter 406 also controls the voltage polarity based on a voltage polarity inversion scheme, such as controlling the voltage polarity inversion frequency. In this example, the data converter 406 causes the polarity of each of the source voltage signals S1-Sn remains the same in at least two consecutive frames of the display data 106. In other words, the data converter 406 controls the voltage polarity inversion frequency to be higher than the frame rate of the display data 106.

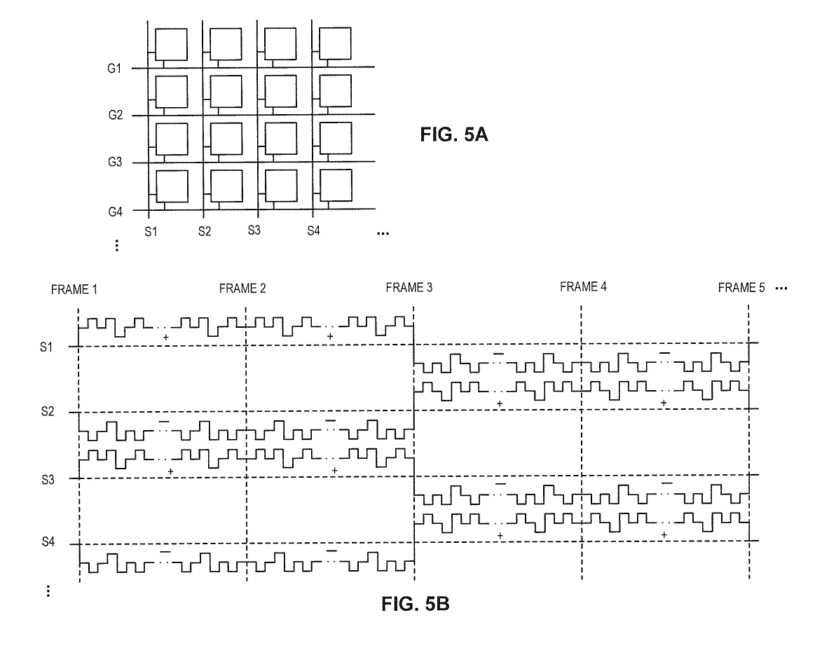

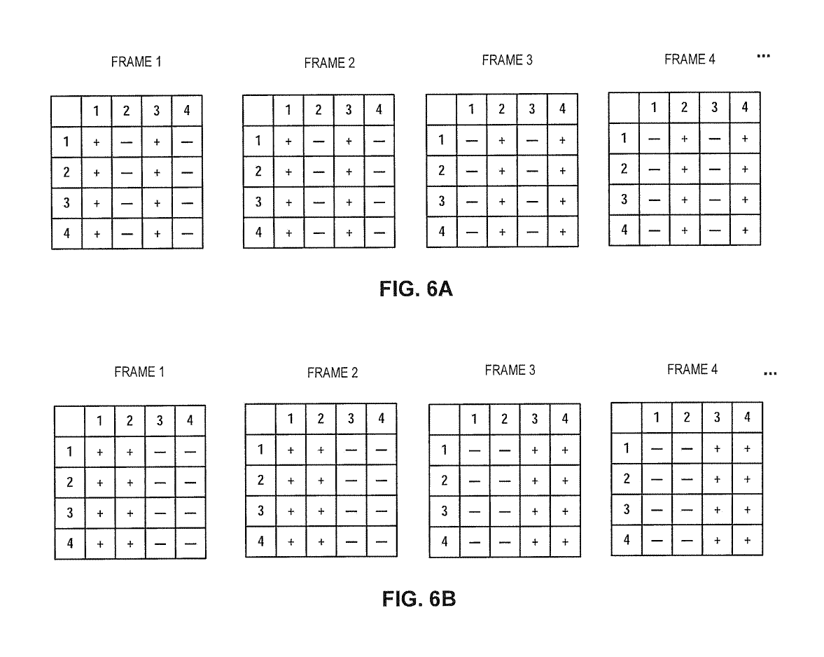

In one embodiment as shown in FIGS. 5A-5B, each of the source voltage signals S1-S4 is applied by the source driving module 306 to the four columns of pixels through the respective scan line (shown in FIG. 5A). Instead of synchronizing with the frame rate, the voltage polarity inversion frequency of each of the source voltage signals S1-S4 is half of the frame rate. In other words, the data converter 406 controls the polarity of each source voltage signal alters in every two consecutive frames. For example, the polarity of S1 remains positive in both frame 1 and frame 2 and then switches to negative and remain negative in both frame 3 and frame 4. The similar polarity alternation scheme is applied to other source voltage signals S2, S3, S4, . . . in this embodiment.

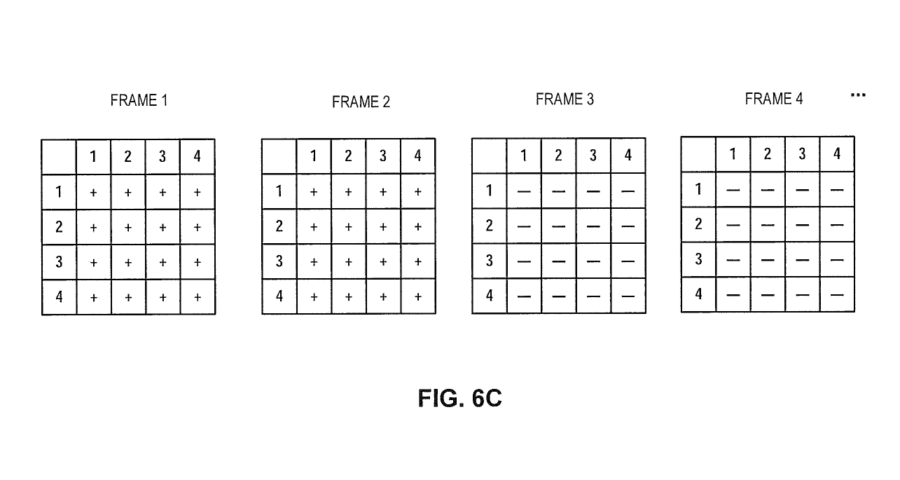

The data converter 406 may apply any novel voltage polarity control approaches set forth in the present disclosure under various voltage polarity inversion schemes. For example, FIGS. 6A-6C are depictions of various voltage polarity inversion schemes in display driving in accordance with different embodiments set forth in the disclosure. FIGS. 6A-6B illustrate exemplary applications of the novel voltage polarity control approaches set forth in the present disclosure to various column inversion schemes. FIG. 6A is directed to the standard column inversion scheme in which within each frame, polarities of source voltage signals applied to every two adjacent columns of pixels are opposite to each other. That is, in this example, at the pixel column level, the polarity of voltage signal alters in every column. While within each frame, the polarities of all pixel voltages in the same column are the same. Different from the traditional column inversion scheme in which the polarity of each column of pixels alters in every frame, in this example the polarity of each column of pixels alters in every two frames, thereby reducing the power consumption caused by source line charge or discharge. The timing diagram as depicted in FIG. 5B is one example of applying the novel voltage polarity control approach to the column inversion scheme shown in FIG. 6A.

FIG. 6B is directed to the 2-column inversion scheme in which within each frame, polarities of source voltage signals applied to each of two adjacent columns of pixels are the same. That is, in this example, at the pixel column level, the polarity of voltage signal alters in every two adjacent columns. While within each frame, the polarities of all pixel voltages in the same column are the same. Different from the traditional 2-column inversion scheme in which the polarity of each column of pixels alters in every frame, in this example the polarity of each column of pixels alters in every two frames, thereby reducing the power consumption caused by source line charge or discharge. It is understood that the novel voltage polarity control approaches set forth in the present disclosure may be similarly applied to any other column inversion schemes, for example, the 3-column inversion scheme.

FIG. 6C illustrate the exemplary application of the novel voltage polarity control approaches set forth in the present disclosure to the frame inversion scheme. FIG. 6C is directed to the frame inversion scheme in which within each frame, polarities of source voltage signals applied to each column of pixels are the same. That is, in this example, the polarities of all the source voltage signals are the same within each frame. Different from the traditional frame inversion scheme in which the polarity of each column of pixels alters in every frame, in this example the polarity of each column of pixels alters in every two frames, thereby reducing the power consumption caused by source line charge or discharge.

It is understood that the novel voltage polarity control approaches set forth in the present disclosure can be applied to any other voltage polarity inversion schemes besides the ones illustrated in FIGS. 6A-6C so long as, for each source line (pixel column), the voltage polarity remains the same within a frame. For example, as shown in FIG. 5B, within any one of the frames (e.g., frame 1), although the voltage magnitude for each source line (e.g., S1) varies between pixels in different rows, the voltage polarity remains the same within that frame (e.g., positive for S1 within frame 1).

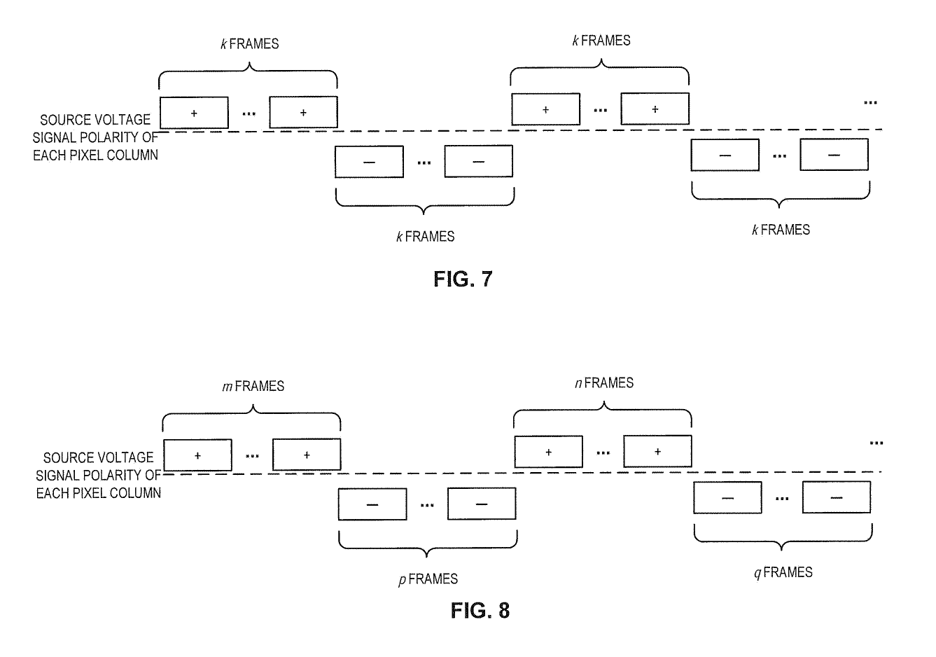

FIGS. 7-8 are timing diagrams of source voltage signal polarity of each pixel column in accordance with different embodiments set forth in the disclosure. In FIGS. 5B and 6A-6C, the polarity of each source voltage signal alters in every two consecutive frames. It is understood that, however, in other examples (as illustrated in FIG. 7), the data converter 406 may control the polarity of each source voltage signal alters in every k consecutive frames, where k is an integer of at least 2. That is, the voltage polarity inversion frequency may be 1/k of the frame rate. To avoid liquid crystal polarization, the voltage polarity inversion frequency cannot be too low. The minimum voltage polarity inversion frequency may be determined based on the ion impurity densities of different liquid crystal materials: the higher the impurity density is, the higher the minimum voltage polarity inversion frequency is. In one example, the minimum voltage polarity inversion frequency is 1 Hz. That is, if the display frame rate is 60 Hz, the polarity of each source voltage signal may alter at most in every 60 consecutive frames (and at least in every two consecutive frames).

As shown in FIG. 7, the duration of positive frames and duration of negative frames are symmetrically the same (e.g., k+, k−, k+, k−, . . . ). FIG. 8 illustrates another embodiment in which the duration of positive frames and duration of negative frames are not symmetrically the same, but can be dynamically set as long as they are the total durations of positive frames and total duration of negative frames are the same in a certain time period. As shown in FIG. 8, the polarity of source voltage signal for each pixel column remains positive for m consecutive frames and then switches to negative and remains negative for another p consecutive frames; the voltage polarity again switches back to positive and remains positive for another n consecutive frames and switches to negative and remains negative for another q consecutive frames. That is, the voltage polarity may be dynamically kept the same for several frames and then switched and dynamically kept for another several frames. In a certain time period, assuming the polarity of the source voltage signal applied to each pixel column is positive in a total of i frames and is negative in a total of j frames, then the i positive frames include at least the m consecutive frames and the n consecutive frames as mentioned above; the j negative frames include at least the p consecutive frames and the q consecutive frames as mentioned above. In this example, the total number (durations) of positive frame is the same as the total number (durations) of negative frames in the certain time period (i=j, or m+n+ . . . =p+q+ . . . ). In one example, the certain time period is not more than 1 second. Different from the embodiment shown in FIG. 7, in this embodiment, m, n, and other numbers of consecutive positive frames (if any) cannot all be the same; p, q, and other numbers of consecutive negative frames (if any) cannot all be the same either. As mentioned above, the voltage polarity for each pixel column (source line) remains the same in at least two consecutive frames. That is, in order to make the voltage polarity inversion frequency less than the frame rate, in the embodiment shown in FIG. 8, m, n, p, q, . . . cannot all be 1. The values of m, n, p, q, . . . can thus be dynamically determined based on the conditions mentioned above.

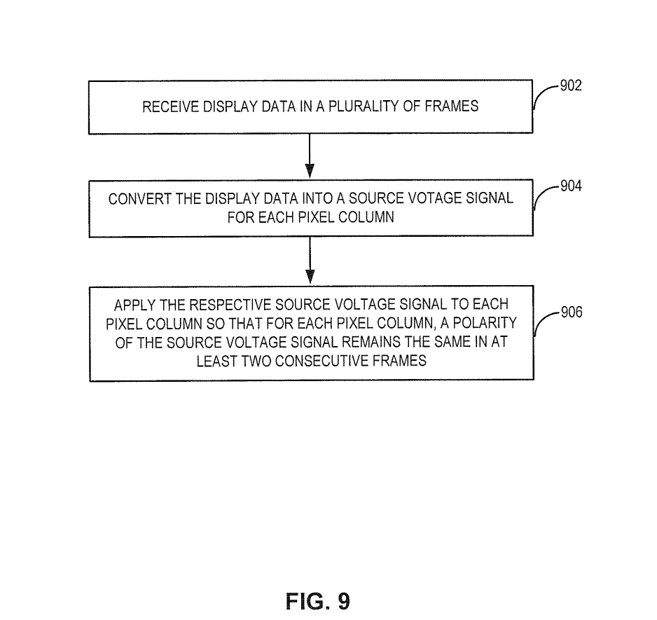

FIG. 9 is a flow chart illustrating one example of a method for driving the display 101 having an array of pixels. It will be described with reference to the above figures. However, any suitable logic, units, or circuits may be employed. Beginning at 902, display data in a plurality of frames is received. The display data includes, for each pixel for display, primary color information, e.g., read (R), green (G), and blue (B), to be displayed in consecutive frames. As described above, 902 may be performed by the source driving module 306, such as the data storage 404. Proceeding to 904, the received display data is converted into a source voltage signal for each column of the array of the pixels. As described above, 904 may be performed by the source driving module 306, such as the data converter 406. At 906, the respective source voltage signal is applied to each column of the array of the pixels. As described above, 906 may be performed by the source driving module 306, such as the source driver 408. For each column of the array of the pixels, a polarity of the source voltage signal applied to the column remains the same in at least two consecutive frames of the plurality of frames. As mentioned above with respect to FIGS. 6A-6C, the novel display driving method illustrated in FIG. 9 can be applied to various voltage polarity inversion schemes, such as the column inversion scheme, 2-column inversion scheme, frame inversion scheme, etc. As mentioned above with respect to FIGS. 7-8, the novel display driving method illustrated in FIG. 9 can be either “static” in the sense that the duration of positive frames and duration of negative frames are symmetrically the same or can be “dynamic” in the sense that the voltage polarity can be dynamically kept for several frames.

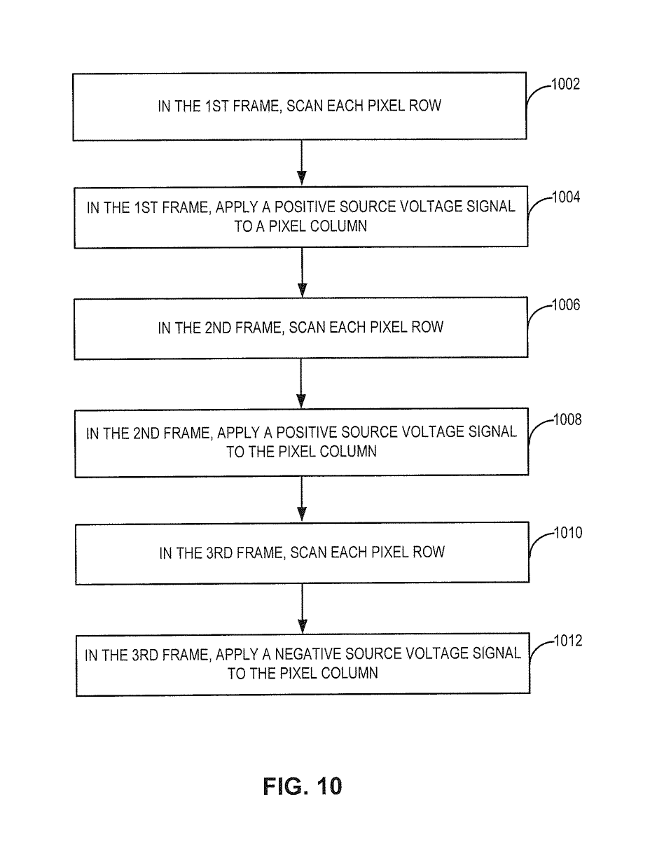

FIG. 10 is a flow chart illustrating another example of a method for driving the display 101 having an array of pixels. It will be described with reference to the above figures. However, any suitable logic, units, or circuits may be employed. Beginning at 1002, in the first frame, each pixel row is scanned. At 1004, in the same first frame, a positive source voltage signal is applied to a pixel column. Proceeding to 1006, in the second frame that is immediately after the first frame, each pixel row is scanned again. At 1008, in the same second frame, a positive source voltage signal is applied to the same pixel column. That is, the polarity of source voltage signal applied to the pixel column remains the same in two consecutive frames. Proceeding to 1010, in the third frame, each pixel row is scanned again. At 1012, in the same third frame, a negative source voltage signal is applied to the pixel column. As described above, 1002, 1006, and 1010 may be performed by the gate driving module 304, and 1004, 1008, and 1012 may be performed by the source driving module 306.

Aspects of the method for driving a display, as outlined above, may be embodied in programming. Program aspects of the technology may be thought of as “products” or “articles of manufacture” typically in the form of executable code and/or associated data that is carried on or embodied in a type of computer-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a computer-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer-readable media may be involved in carrying one or more sequences of one or more instructions to a processor for execution.

Also, integrated circuit design systems (e.g. work stations) are known that create wafers with integrated circuits based on executable instructions stored on a computer-readable medium such as but not limited to CDROM, RAM, other forms of ROM, hard drives, distributed memory, etc. The instructions may be represented by any suitable language such as but not limited to hardware descriptor language (HDL), Verilog or other suitable language. As such, the logic, units, and circuits described herein may also be produced as integrated circuits by such systems using the computer-readable medium with instructions stored therein. For example, an integrated circuit with the aforedescribed logic, units, and circuits may be created using such integrated circuit fabrication systems. The computer-readable medium stores instructions executable by one or more integrated circuit design systems that causes the one or more integrated circuit design systems to design an integrated circuit. The designed integrated circuit includes a data storage, a data converter, and a source driver. The data storage is configured to receive display data in a plurality of frames. The data converter is operatively coupled to the data storage and configured to convert the received display data into a source voltage signal for each column of the array of the pixels. The source driver is operatively coupled to the data converter and configured to apply the respective source voltage signal to each column of the array of the pixels. For each column of the array of the pixels, a polarity of the source voltage signal applied to the column remains the same in at least two consecutive frames of the plurality of frames.

The above detailed description of the disclosure and the examples described therein have been presented for the purposes of illustration and description only and not by limitation. It is therefore contemplated that the present disclosure cover any and all modifications, variations or equivalents that fall within the spirit and scope of the basic underlying principles disclosed above and claimed herein.

What is claimed is:

1. An apparatus for driving a display panel having an array of pixels, comprising a source driving module comprising:
a data storage configured to receive display data in a plurality of frames;
a data converter operatively coupled to the data storage and configured to convert the received display data into a source voltage signal for each column of the array of the pixels; and
a source driver operatively coupled to the data converter and configured to apply the respective source voltage signal to each column of the array of the pixels, wherein
for each column of the array of the pixels, a polarity of the source voltage signal applied to the column remains the same in at least two consecutive frames of the plurality of frames.

2. The apparatus of claim 1, wherein for each column of the array of the pixels, the polarity of the source voltage signal applied to the column alters in every k consecutive frames of the plurality of frames, k being an integer of at least 2.

3. The apparatus of claim 1, wherein, for each column of the array of the pixels in a time period,
the polarity of the source voltage signal applied to the column is positive in i frames and is negative in j frames;
the i frames in which the polarity of the source voltage signal is positive include at least a first m consecutive frames and a second n consecutive frames, m being different from n; and
the j frames in which the polarity of the source voltage signal is negative include at least a first p consecutive frames and a second q consecutive frames, p being different from q.

4. The apparatus of claim 3, wherein i equals to j.

5. The apparatus of claim 4, wherein the time period is not more than 1 second.

6. The apparatus of claim 1, wherein in each of the plurality of frames, polarities of source voltage signals applied to every two adjacent columns of the array of the pixels are opposite to each other.

7. The apparatus of claim 1, wherein in each of the plurality of frames, polarities of source voltage signals applied to each of a plurality of adjacent columns of the array of the pixels are the same.

8. The apparatus of claim 1, wherein in each of the plurality of frames, polarities of source voltage signals applied to each of two adjacent columns of the array of the pixels are the same.

9. The apparatus of claim 1, wherein the display panel is a liquid crystal display (LCD) panel.

10. The apparatus of claim 1, further comprising:
a timing controller configured to receive the display data and provide control signals based on the display data; and
a gate driving module operatively coupled to the timing controller and configured to scan each row of the array of the pixels in each of the plurality of frames based on the control signals.

11. An apparatus comprising:
a liquid crystal display (LCD) panel having an array of pixels; and
a display driver operatively coupled to the LCD panel and configured to drive the array of pixels on the LCD panel, the display driver comprising:
a timing controller configured to receive display data in a plurality of frames and provide control signals based on the display data,
a gate driving module operatively coupled to the timing controller and configured to scan each row of the array of the pixels in each of the plurality of frames based on the control signals, and
a source driving module configured to apply a source voltage signal to each column of the array of the pixels based on the control signals, wherein
for each column of the array of the pixels, a polarity of the source voltage signal applied to the column remains the same in at least two consecutive frames of the plurality of frames.

12. The apparatus of claim 11, wherein the source driving module comprises:
a data storage configured to store the display data;
a data converter operatively coupled to the data storage and configured to convert the stored display data into the respective source voltage signal for each column of the array of the pixels so that, for each column of the array of the pixels, the polarity of the source voltage signal applied to the column remains the same in at least two consecutive frames of the plurality of frames; and
a source driver operatively coupled to the data converter and configured to apply the respective source voltage signal to each column of the array of the pixels.

13. The apparatus of claim 11, wherein for each column of the array of the pixels, the polarity of the source voltage signal applied to the column alters in every k consecutive frames of the plurality of frames, k being an integer of at least 2.

14. The apparatus of claim 11, wherein, for each column of the array of the pixels in a time period,
the polarity of the source voltage signal applied to the column is positive in i frames and is negative in j frames;
the i frames in which the polarity of the source voltage signal is positive include at least a first m consecutive frames and a second n consecutive frames, m being different from n; and
the j frames in which the polarity of the source voltage signal is negative include at least a first p consecutive frames and a second q consecutive frames, p being different from q.

15. The apparatus of claim 14, wherein i equals to j.

16. The apparatus of claim 15, wherein the time period is not more than 1 second.

17. The apparatus of claim 11, wherein in each of the plurality of frames, polarities of source voltage signals applied to every two adjacent columns of the array of the pixels are opposite to each other.

18. The apparatus of claim 11, wherein in each of the plurality of frames, polarities of source voltage signals applied to each of a plurality of adjacent columns of the array of the pixels are the same.

19. The apparatus of claim 11, wherein in each of the plurality of frames, polarities of source voltage signals applied to each of two adjacent columns of the array of the pixels are the same.

20. A method for driving a display panel having an array of pixels, comprising:
receiving display data in a plurality of frames;
converting the received display data into a source voltage signal for each column of the array of the pixels; and
applying the respective source voltage signal to each column of the array of the pixels, wherein
for each column of the array of the pixels, a polarity of the source voltage signal applied to the column remains the same in at least two consecutive frames of the plurality of frames.
